(19) United States
(12) Patent Application Publication
(10) Pub. No.: US 2017/0197170 A1
(43) Pub. Date: Jul. 13, 2017

(54) DEFECT TOLERANT HONEYCOMB STRUCTURES

(71) Applicant: CORNING INCORPORATED, CORNING, NY (US)

(72) Inventors: Douglas Munroe Beall, Painted Post, NY (US); Jason Thomas Harris, Horseheads, NY (US); Seth Thomas Nickerson, Corning, NY (US); Krishna Hemanth Vepakomma, Painted Post, NY (US)

(73) Assignee: CORNING INCORPORATION, CORNING, NY (US)

(21) Appl. No.: 15/327,803

(22) PCT Filed: Jul. 21, 2015
(86) PCT No.: PCT/US15/41287

§ 371 Date: Jan. 20, 2017

Related U.S. Application Data
(60) Provisional application No. 62/029,040, filed on Jul. 25, 2014.

(51) Int. Cl. B01D 46/24; B01J 35/04; B01D 53/94

(52) U.S. Cl. CPC B01D 46/2474; B01D 46/247; B01D 46/2425; B01D 53/94; B01J 35/04; B01D 2046/2481; B01D 2046/2492; B01D 2046/2496; B01D 2255/915

(57) ABSTRACT

In one embodiment, a honeycomb structure formed from ceramic material, or ceramic honeycomb structure, includes at least one outer wall defining a perimeter of the honeycomb structure. A plurality of primary zone partitions and secondary zone partitions may extend in an axial direction of the honeycomb structure and across a width of the honeycomb structure. The primary zone partitions and the secondary zone partitions intersect with one another to divide a radial cross section of the honeycomb structure into a plurality of zones. The primary zone partitions and the secondary zone partitions may have a single-wall thickness with a maximum thickness T_{zmax}. Each zone may comprise a plurality of channel walls intersecting to subdivide the zone into a plurality of through channels extending in the axial direction of the honeycomb structure, the plurality of channel walls within each zone having a thickness of at least tc and T_{Zmax}>2t_{C}.

### CROSS-REFERENCE TO RELATED APPLICATIONS

This application claims the benefit of priority under 35 U.S.C. §119 of U.S. Provisional Application Ser. No. 62/029,040 filed on Jul. 25, 2014 the content of which is relied upon and incorporated herein by reference in its entirety.

### BACKGROUND

Field

The present specification generally relates to honeycomb structures for use in filtration and/or catalyst applications and, more specifically, to honeycomb structures for use in filtration and/or catalyst applications that are tolerant to defects.

Technical Background

Honeycomb structures, such as honeycomb structures formed from ceramic materials, are widely used as anti-pollution devices in consumer and commercial equipment. For example, honeycomb structures may be used in the exhaust systems of vehicles, both as catalytic converter substrates and as particulate filters. The honeycomb structures are generally formed from a matrix of thin, porous ceramic walls (also referred to as “webs”) which define a plurality of parallel, gas conducting channels.

The thin, porous walls of the honeycomb structure make the structures susceptible to damage and/or breakage due to mechanical impacts and/or as a result of extreme temperature fluctuations experienced during use. In particular, the isostatic strength of honeycomb structures is primarily limited by geometric imperfections in the matrix of thin, porous walls. For example, during manufacture of the honeycomb structure, it is common that the matrix of webs forming the structure may contain one or more geometric anomalies, such as bent or missing webs. A single geometric anomaly out of the many thousands of webs in a honeycomb structure may significantly decrease the isostatic strength of the honeycomb structure, potentially leading to mechanical failure of the structure during use and/or handling.

Inspection systems are routinely employed to identify geometric defects created in honeycomb structures during manufacture. Honeycomb structures having geometric defects exceeding an established threshold may be discarded. However, the regular occurrence of such defects can result in significant production losses and, as a result, increased product costs.

Accordingly, a need exists for alternative methods of decreasing the sensitivity of honeycomb structures to defects, thereby improving the isostatic strength of honeycomb structures with such defects.

### SUMMARY

According to one embodiment, a honeycomb structure formed from ceramic material, or ceramic honeycomb structure, comprises at least one outer wall defining a perimeter of the honeycomb structure. A plurality of primary zone partitions may extend in an axial direction of the honeycomb structure and across a width of the honeycomb structure. The primary zone partitions may be substantially parallel with one another and opposite ends of each primary zone partition intersect with the at least one outer wall in the width direction. A plurality of secondary zone partitions may extend in an axial direction and intersecting with the primary zone partitions. The primary zone partitions and the secondary zone partitions divide a radial cross section of the honeycomb structure into a plurality of zones. The primary zone partitions and the secondary zone partitions may have a single-wall thickness with a maximum thickness T_{Zmax}. Adjacent zones may be separated by a single primary zone partition or a single secondary zone partition. Each zone may comprise a plurality of channel walls intersecting to subdivide the zone into a plurality of through channels extending in the axial direction of the honeycomb structure, the plurality of channel walls within each zone having a thickness of at least t_{C} and T_{Zmax}>2t_{C}.

In another embodiment, a honeycomb structure formed from ceramic material, or ceramic honeycomb structure, may comprise at least one outer wall defining a perimeter of the honeycomb structure. A plurality of primary zone partitions may extend in an axial direction of the honeycomb structure and across a width of the honeycomb structure. The primary zone partitions may be substantially parallel with one another and opposite ends of each primary zone partition may intersect with the at least one outer wall in the width direction. A plurality of secondary zone partitions may extend in an axial direction and intersect with the primary zone partitions. The primary zone partitions and the secondary zone partitions may divide a radial cross section of the honeycomb structure into a plurality of zones. The primary zone partitions and the secondary zone partitions may have a single-wall thickness with a maximum thickness T_{Zmax}. Adjacent zones may be separated by a single primary zone partition or a single secondary zone partition. Each zone may comprise a plurality of channel walls intersecting to subdivide the zone into a plurality of through channels extending in the axial direction of the honeycomb structure. The plurality of channel walls within each zone may have a thickness less than T_{Zmax} and greater than or equal to t_{C}. The plurality of channel walls within each zone may be thicker adjacent to the primary zone partitions and the secondary zone partitions than at a center of each zone and T_{Zmax}>2t_{C}.

Additional features and advantages of the honeycomb structures described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a honeycomb structure according to one or more embodiments shown and described herein;

FIG. 2 schematically depicts a partial cross section of a honeycomb structure according to one or more embodiments shown and described herein;

FIG. 3 schematically depicts a cross section of a zone of a honeycomb structure in which the channel walls within the zone decrease in thickness towards a center of the zone;

FIG. 4 schematically depicts a partial cross section of a honeycomb structure with hexagonal through channels according to one or more embodiments shown and described herein;

FIGS. 5A-5C schematically depict geometrical anomalies which may occur in a honeycomb structure;

FIG. 6 graphically depicts the isostatic strength of two honeycomb structures (normalized to the inverse of the peak applied tensile stress) as a function of the thickness of the primary zone partitions and the secondary zone partitions;

FIG. 7 graphically depicts the isostatic strength of a reinforced honeycomb structure and an unreinforced honeycomb structure (normalized to the inverse of the peak applied tensile stress) as a function of the number of adjacent channel walls with cut webs in between; and

FIG. 8 graphically depicts the normalized specific strength (relative isostatic strength/bulk density) for (1) an unreinforced honeycomb structure; (2) a reinforced honeycomb structure; and (3) an unreinforced honeycomb structure having an equivalent bulk density to the reinforced honeycomb structure.

### DETAILED DESCRIPTION

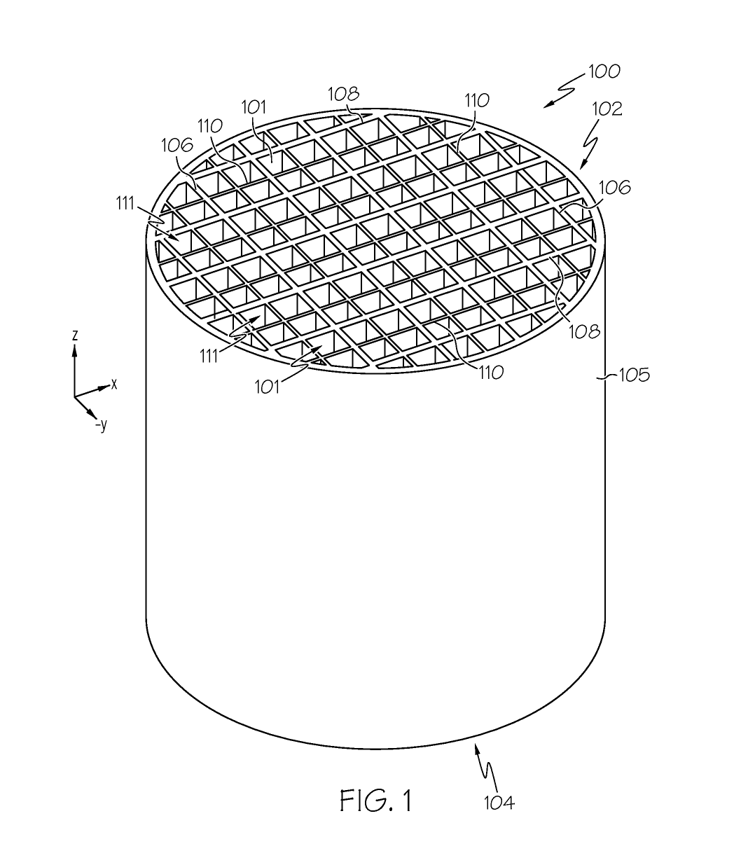

Reference will now be made in detail to embodiments of defect tolerant honeycomb structures, examples of which are illustrated in the accompanying drawings. Whenever possible, the same reference numerals will be used throughout the drawings to refer to the same or like parts. One embodiment of a defect tolerant honeycomb structure is depicted in FIG. 1, and is designated generally throughout by the reference numeral 100. The honeycomb structure may generally comprise at least one outer wall defining a perimeter of the honeycomb structure. A plurality of primary zone partitions may extend in an axial direction of the honeycomb structure and across a width of the honeycomb structure. The primary zone partitions may be substantially parallel with one another and opposite ends of each primary zone partition may intersect with the at least one outer wall in the width direction. A plurality of primary zone partitions may extend in an axial direction and intersect with the primary zone partitions. The primary zone partitions and the secondary zone partitions may divide a radial cross section of the honeycomb structure into a plurality of zones. The primary zone partitions and the secondary zone partitions may have a single-wall thickness with a maximum thickness T_{Zmax}. Adjacent zones may be separated by a single primary zone partition or a single secondary zone partition. Each zone may comprise a plurality of channel walls intersecting to subdivide the zone into a plurality of through channels extending in the axial direction of the honeycomb structure. The plurality of channel walls within each zone may have a thickness of at least t_{C}. T_{Zmax} may be greater than 2t_{C}. Various embodiments of defect tolerant honeycomb structures will be described herein with specific reference to the appended drawings.

As used herein, the phrase “isostatic strength” refers to the maximum isostatic pressure (in MPa) a honeycomb structure is able to withstand without failure. The isostatic strength is determined by applying a uniform pressure to “squeeze” the honeycomb structure in a radial direction. The isostatic pressure is increased until failure occurs in order to determine the isostatic strength of the honeycomb.

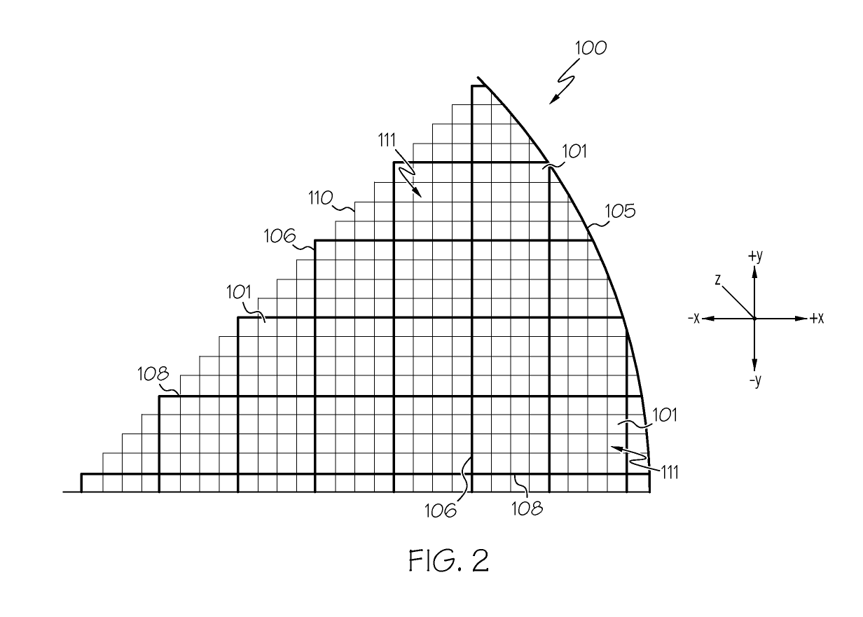

Referring now to FIGS. 1 and 2, a honeycomb structure 100 is schematically depicted in FIG. 1 and a portion of a radial cross section of a honeycomb structure 100 is schematically depicted in FIG. 2. The honeycomb structure 100 may be used as a filter to filter particulate matter from a gas stream (such as an exhaust gas stream) and/or as a catalytic substrate to catalyze specific species of contaminants which may be entrained in a gas stream. In the embodiments described herein, the honeycomb structure 100 may be made from ceramic materials, such as, for example, cordierite, silicon carbide, aluminum oxide, aluminum titanate or any other ceramic material suitable for use at elevated temperatures. Alternatively, the honeycomb structure 100 may be made from catalytically active materials such as, for example, zeolite.

The honeycomb structure 100 generally comprises a honeycomb body having a plurality of through channels 101 or cells which extend in an axial direction (i.e., in the +/−Z direction of the coordinate axes depicted in FIG. 1) between an inlet end 102 and an outlet end 104. The honeycomb structure 100 also comprises an outer wall 105 (also referred to as a “skin”) surrounding the plurality of channels 101. This outer wall 105 may be extruded during initial formation of the honeycomb structure or may be formed in a later processing step as an after-applied skin layer, such as by applying a skinning cement to the outer peripheral portion of the channels.

The through channels 101 of the honeycomb structure 100 are grouped within discrete zones 111. The zones 111, and at least a portion of some of the through channels 101 located within each zone 111, are defined by the intersection of a plurality of primary zone partitions 106 and a plurality of secondary zone partitions 108. The plurality of primary zone partitions 106 generally extend in an axial direction of the honeycomb structure 100 and also extend in a width of the honeycomb structure (i.e., in the +/−Y direction of the coordinate axes depicted in FIG. 1), intersecting with the outer wall 105 at a perimeter of the honeycomb structure 100. In embodiments, the plurality of primary zone partitions 106 are substantially parallel with each other. The plurality of secondary zone partitions 108 extend in an axial direction of the honeycomb structure and intersect with the primary zone partitions 106 such that the primary zone partitions 106 and the secondary zone partitions 108 divide a radial cross section (i.e., a cross section of the honeycomb structure 100 in a plane parallel to the X-Y plane of the coordinate axes shown in FIG. 1) into a plurality of zones 111.

In some embodiments, the plurality of primary zone partitions 106 and the plurality of secondary zone partitions 108 have a uniform thickness T_{Z} which is constant across the radial cross section of the honeycomb structure 100 (i.e., T_{Z}=T_{Zmax}, wherein T_{Zmax} is a maximum thickness of the primary zone partitions 106 and the secondary zone partitions 108), as depicted in FIGS. 1 and 2. In some other embodiments, the thickness of the primary zone partitions 106 and/or the secondary zone partitions 108 may vary between the points of intersection of the primary zone partitions 106 with the secondary zone partitions 108 and/or between the intersection of the primary zone partitions 106 or the secondary zone partitions 108 with the outer wall 105 and the intersection of the primary zone partitions 106 with the secondary zone partitions 108. In some embodiments, the maximum thickness T_{Zmax} of the primary zone partitions 106 and the secondary zone partitions 108 may occur at locations between the intersections. Alternatively, the maximum thickness T_{Zmax} of the primary zone partitions 106 and the secondary zone partitions 108 may occur at the points of intersection. Regardless of the embodiment, it should be understood that the primary zone partitions 106 and the second zone partitions 108 have a maximum thickness T_{Zmax}.

In the embodiments described herein, the primary zone partitions 106 and the secondary zone partitions 108 have a single wall thickness, meaning that the primary zone partitions 106 and the secondary zone partitions 108 do not include any through channels within the thickness of either the primary zone partitions 106 or the secondary zone partitions 108. Further, adjacent zones 111 are separated by a single primary zone partition or a single secondary zone partition.

Still referring to FIGS. 1 and 2, the through channels 101 of the honeycomb structure 100 are positioned in the zones 111. Specifically, each of the zones 111 comprises a plurality of channel walls 110 that extend in the axial direction of the honeycomb structure 100. The plurality of channel walls 110 intersect with one another and with the primary zone partitions 106 and the secondary zone partitions 108 to form the through channels 101. In the embodiments described herein, the full through channels 101 (i.e., those through channels that are not directly adjacent to the outer wall 105 of the honeycomb structure, as distinguished from partial through channels which are directly adjacent to and at least partially bounded by the outer wall 105) are bound by at least one channel wall 110. In other words, each full through channel 101 is bounded by either channel walls 110 or a combination of channel walls 101 and at least one of a primary zone partition 106 and a secondary zone partition 108.

In the embodiments described herein, the channel walls 110, the primary zone partitions 106, and the secondary zone partitions 108 are sized to improve the isostatic strength and damage tolerance of the honeycomb structure 100. Specifically, in the embodiments described herein, the primary zone partitions 106 and the secondary zone partitions 108 have a greater thickness than the channel walls 110. By enclosing each of the zones 111 with primary zone partitions 106 and secondary zone partitions 108 which have wall thicknesses greater than the channel walls 110 within the zones 111, the strength reducing effects of any geometric anomalies in the channel walls 110 within the zones 111 can be locally isolated to the corresponding zone 111, thereby increasing the isostatic strength and damage tolerance of the honeycomb structure.

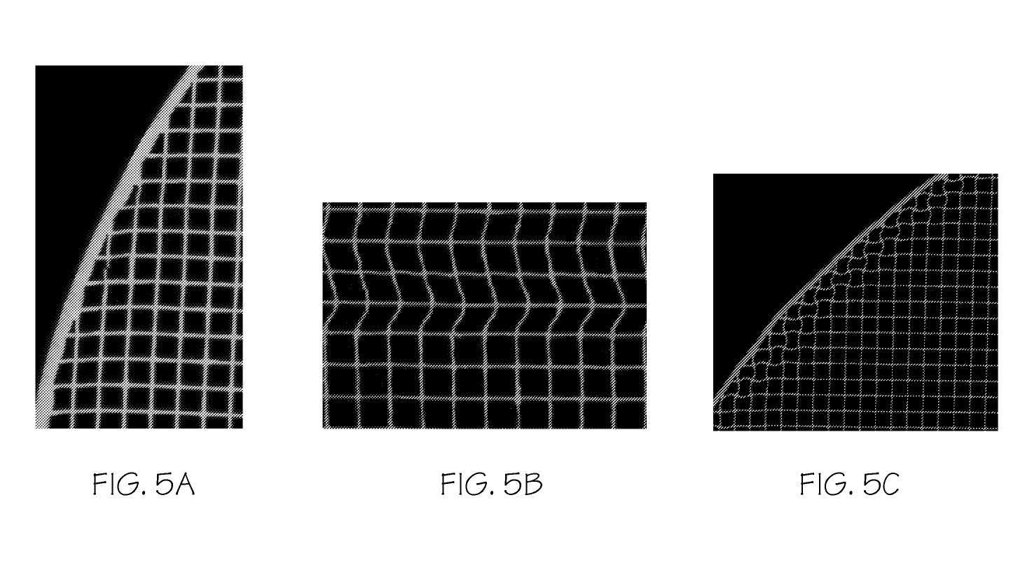

In particular, in a conventional honeycomb structure (i.e., a honeycomb structure without thickened primary zone partitions and secondary zone partitions) which includes defects such as bent webs (shown in FIGS. 5B and 5C) or “non-knitting” webs (shown in FIG. 5C), isostatic pressure exerted on the outer wall of the honeycomb structure is transferred from the outer wall to the center of the honeycomb structure through the channel walls or “webs.” However, where a channel wall is bent, disconnected, or missing, the honeycomb structure is locally weakened. When this weakened area is subjected to sufficient isostatic pressure, the surrounding channel walls may buckle towards the defect and fracture under the applied load which, in turn, causes a cascade of failures emanating from the locally weakened area, ultimately leading to failure of the honeycomb structure.

However, in a honeycomb structure 100 which has primary zone partitions 106 and secondary zone partitions 108 which divide the honeycomb structure 100 into a plurality of zones 111 and have a thickness greater than the channel walls, any defects located within the zones 111 are effectively isolated from the applied isostatic pressure by the primary zone partitions 106 and the secondary zone partitions 108. Specifically, any isostatic pressure applied to the outer wall of the honeycomb structure 100 is distributed between and amongst the zones 111, collectively, through the primary zone partitions 106 and the secondary zone partitions 108, rather than through the less robust channel walls of the zones 111, thereby preventing failure from any areas within zones 111 which may be locally weakened due to the presence of defects.

In the honeycomb structures 100 described herein, the channel walls 110, the primary zone partitions 106, and the secondary zone partitions 108 are formed such that T_{Zmax} of the primary zone partitions 106 and the secondary zone partitions 108 is greater than 2t_{C}. In particular, it has been determined that the isostatic strength and defect tolerance of the honeycomb structure 100 is not significantly improved if the maximum thickness T_{Zmax} of the primary zone partitions 106 and the secondary zone partitions 108 is less than or equal to 2t_{C}. In some embodiments, the channel walls 110, primary zone partitions 106, and the secondary zone partitions 108 are formed such that T_{Zmax} of the primary zone partitions 106 and the secondary zone partitions 108 is greater than or equal to 3t_{C} or even greater than or equal to 4t_{C}.

It has also been found that increasing the maximum thickness T_{Zmax} of the primary zone partitions 106 and the secondary zone partitions 108 may diminish other characteristics of the honeycomb structure 100, such as reducing open frontal area, increasing the pressure drop across the honeycomb structure, and increasing the thermal mass of the honeycomb structure. Accordingly, in the embodiments described herein, the channel walls 110, the primary zone partitions 106, and the secondary zone partitions 108 are formed such that T_{Zmax} of the primary zone partitions 106 and the secondary zone partitions 108 is less than or equal to 10t_{C}. In some embodiments, the channel walls 110, the primary zone partitions 106, and the secondary zone partitions 108 may be formed such that T_{Zmax} of the primary zone partitions 106 and the secondary zone partitions 108 is less than or equal to 8t_{C} or even less than or equal to 7t_{C}. For example, the channel walls 110, the primary zone partitions 106, and the secondary zone partitions 108 may be formed such that T_{Zmax} of the primary zone partitions 106 and the secondary zone partitions 108 is less than or equal to 6t_{C} or even less than or equal to 5t_{C}.

Accordingly, it should be understood that, in some embodiments the channel walls 110, the primary zone partitions 106, and the secondary zone partitions 108 may be formed such that T_{Zmax} of the primary zone partitions 106 and the secondary zone partitions 108 is in a range from greater than 2t_{C} to less than or equal to 10t_{C} or even from greater than 2t_{C} to less than or equal to 8t_{C}. In some embodiments, the channel walls 110, the primary zone partitions 106, and the secondary zone partitions 108 may be formed such that T_{Zmax} of the primary zone partitions 106 and the secondary zone partitions 108 is in a range from greater than 2t_{C} to less than or equal to 7t_{C} or even from greater than 2t_{C} to less than or equal to 6t_{c}. In still other embodiments, the channel walls 110, the primary zone partitions 106, and the secondary zone partitions 108 may be formed such that T_{Zmax} of the primary zone partitions 106 and the secondary zone partitions 108 is in a range from greater than 2t_{C} to less than or equal to 5t_{C}.

In the embodiments described herein, the channel walls 110 of the honeycomb structure 100 generally have a wall thickness in the range from greater than or equal to about 25 microns to less than or equal to about 520 microns. In some embodiments, the channel walls 110 of the honeycomb structure 100 may have a wall thickness in the range from greater than or equal to about 25 microns to less than or equal to about 205 microns. In some other embodiments, the channel walls 110 of the honeycomb structure 100 may have a wall thickness in the range from greater than or equal to about 100 microns to less than or equal to about 500 microns.

In the embodiments of the honeycomb structures 100 depicted in FIGS. 1 and 2, the thickness t_{C} of the of the channels walls 110 within each zone 111 is substantially uniform along the length of each channel wall 110 and amongst the several channel walls 110 (i.e., all the channel walls have substantially the same thickness). However, it should be understood that, in other embodiments, the thickness of the channel walls 110 within each zone may vary.

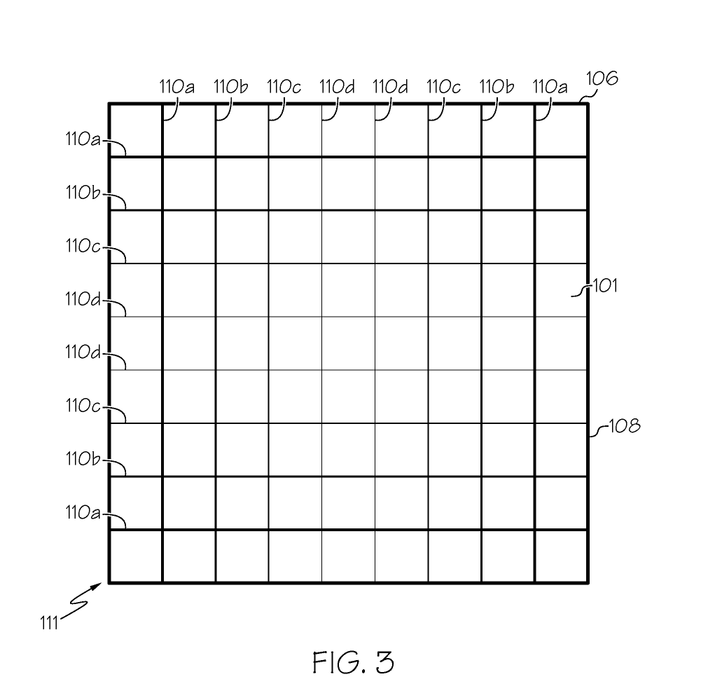

Referring to FIG. 3 which depicts a single zone 111 of a honeycomb structure by way of example, in one embodiment, the plurality of channel walls within each zone are thicker adjacent to the primary zone partitions 106 and the secondary zone partitions 108 than at the center of each zone 111. This adds additional strength to the honeycomb structure 100 and further assists in isolating defects within each zone 111. For example, in the zone 111 depicted in FIG. 3, channel walls 110a adjacent to the primary zone partitions 106 and the secondary zone partitions 108 are thicker than the channel walls 110d located at the center of the zone 111. In embodiments, the thickness of the plurality of channel walls within each zone may decrease in thickness from a perimeter of each zone (i.e., from the primary zone partitions 106 and the secondary zone partitions 108) to the center of each zone 111. For example, in the zone 111 depicted in FIG. 3, the channel walls 110a may be the thickest in the zone 111 and the thickness of the channel walls may be progressively decreased from channel walls 110a, through channel walls 110b-110c, to channel walls 110d at the center of the zone. In one embodiment, the plurality of channel walls within each zone decrease in thickness from less than about T_{Zmax} to t_{C}. In the foregoing embodiments in which the thickness of the channel walls vary, it should understood that the minimum thickness of the channel walls 110 within the zone 111 is t_{C} and that the thickness of the primary zone partitions 106 and the secondary zone partitions 108 are based on the minimum thickness of the channel walls 110.

Referring again to FIGS. 1 and 2 and as noted hereinabove, the thickness of the primary zone partitions 106 and the secondary zone partitions 108 may vary between intersection points. In some embodiments, the thickness of the primary zone partitions 106 vary from t_{C} to T_{Zmax} between the intersection points. In some other embodiments, the thickness of the secondary zone partitions 108 vary from t_{C} to T_{Zmax} between the intersection points. In yet other embodiments, the thicknesses of both the primary zone partitions 106 and the secondary zone partitions 108 vary from t_{C} to T_{Zmax} between the intersection points. Varying the thickness of the primary zone partitions 106 and the secondary zone partitions 108 from t_{C} to T_{Zmax} between the intersection points imparts the maximum strength benefit to the honeycomb structure 100 with the minimum amount of material.

As shown in FIG. 1, each complete zone 111 of the honeycomb structure comprises at least four through channels 101. Accordingly, it should be understood that, in the embodiments described herein, adjacent primary zone partitions 106 are spaced apart by at least two through channels 101. Similarly, adjacent secondary zone partitions 108 are spaced apart by at least two through channels 101. In embodiments described herein, the honeycomb structure 100 may be formed with a channel density of up to about 900 channels per square inch (cpsi). For example, in some embodiments, the honeycomb structure 100 may have a channel density in a range from about 100 cpsi to about 900 cpsi. In some other embodiments, the honeycomb structure 100 may have a channel density in a range from about 300 cpsi to about 900 cpsi. In some other embodiments, the honeycomb structure may have a channel density in a range from about 100 cpsi to about 400 cpsi or even from about 200 cpsi to about 300 cpsi.

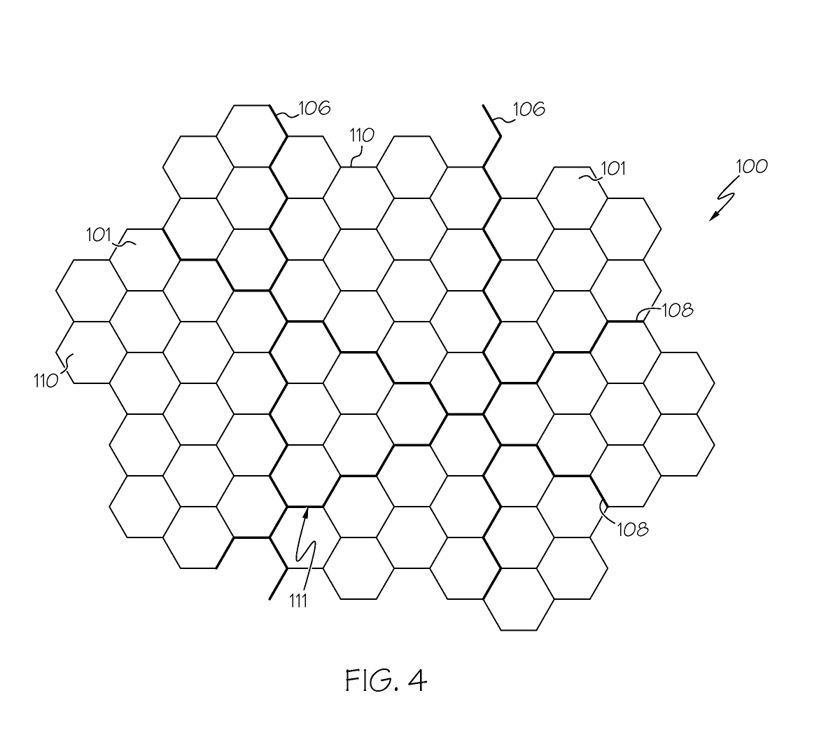

In the embodiments of the honeycomb structures 100 depicted in FIGS. 1 and 2, the plurality of through channels 101 are generally square in cross section. However, it should be understood that other embodiments are contemplated. For example, in one embodiment, the honeycomb structure 100 comprises through channels 101 which are hexagonal in cross section, as depicted in FIG. 4. In this embodiment, the honeycomb structure 100 is divided into zones 111 with a plurality of primary zone partitions 106 and a plurality of secondary zone partitions 108, as described above. Each zone 111 further comprises a plurality of channel walls 110 which subdivide the zones 111 into a plurality of through channels 101. The thickness of the primary zone partitions 106 and the secondary zone partitions 108 relative to the channel walls 110 are as described above with respect to FIGS. 1 and 2. It should be understood that still other cross sectional shapes for the through channels 101 are also contemplated including, without limitation, rectangular, round, oblong, triangular, octagonal, hexagonal, or combinations thereof.

As noted herein, the use of primary zone partitions and secondary zone partitions with thicknesses greater than twice the thickness of the channel walls to create discrete zones of through channels assists in increasing the isostatic strength and defect tolerance of the honeycomb structure by isolating defects within the zones, effectively reducing the sensitivity of the honeycomb structure to geometrical defects. Accordingly, the honeycomb structures described herein are able to better withstand a greater concentration of geometrical defects without a corresponding loss of isostatic strength.

In the embodiments described herein, reinforced honeycomb structures with primary zone partitions and secondary zone partitions having thicknesses greater than 2t_{C} have greater isostatic strength than unreinforced honeycomb structures with the same geometry (i.e., the same through channel density and channel wall thicknesses).

In addition, the reinforced honeycomb structures with primary zone partitions and secondary zone partitions having thicknesses greater than 2t_{C} have greater isostatic strength than unreinforced honeycomb structures with the same bulk density and open frontal area.

In the embodiments described herein, the bulk density for a honeycomb structure with through channels having square cross sections is calculated according to the equation:

$${ρ}_{total} = {ρ}_{material} \cdot [ 2 - {( 1 - \frac{{t}_{std}}{{L}_{std}} )}^{2} - {( 1 - \frac{{t}_{std} ( X - 1 )}{n \cdot {L}_{std}} )}^{2} ]$$

where:
ρₜₒₜₐₗ=total bulk density of the reinforced honeycomb structure
ρₘₐₜₑᵣᵢₐₗ=bulk density of the material from which the honeycomb structure is formed
L_{std}=through channel pitch (through channel spacing)
t_{std}=channel wall thickness in the standard (unreinforced) honeycomb structure
X=zone partition scaling factor (“X” times thicker than standard channel walls)
n=zone partition spacing (every “n” through channels a thicker wall is placed)

The honeycomb structures 100 described herein are generally formed by extrusion such that at least the primary zone partitions, secondary zone partitions and the channel walls are monolithic, for example continuously extruded as a unitary solid from the same batch of ceramic precursor materials. In some embodiments, the primary zone partitions, the secondary zone partitions, the channel walls, and the outer wall are monolithic, for example, continuously extruded as a unitary solid from the same batch of ceramic precursor materials. For example, a batch of ceramic precursor materials may be initially mixed with the appropriate processing aids. The batch of ceramic precursor materials is then extruded and dried to form a green honeycomb body having the structure described herein. The specific structure of the green honeycomb body is achieved by extruding the batch of ceramic precursor materials through a die which is essentially a “negative” of the radial cross section of the desired honeycomb structure. Thereafter, the green honeycomb body is fired according to a firing schedule suitable for producing a fired honeycomb body.

### EXAMPLES

The embodiments described herein will be further clarified by the following examples.

### Example 1

Computer simulations of honeycomb structures with two different geometries were constructed and the isostatic strength calculated based on modeling parameters. The first honeycomb structure was modeled with square through channels and a 600/2.9 geometry (600 cells per square inch, wall thickness of 2.9 mils (73.66 microns)). The isostatic strength was modeled under three conditions: unreinforced with all channel walls having thicknesses of 1×; reinforced with primary and secondary zone partitions having thicknesses of 2× every four cells; and reinforced with primary and secondary zone partitions having thicknesses of 3× every four cells. The second honeycomb structure had square through channels with a 400/4.5 geometry (400 cells per square inch, wall thickness of 4.5 mils (114.3 microns)) and the isostatic strength was modeled under three conditions: unreinforced with all channel walls having thicknesses of 1×; reinforced with primary and secondary zone partitions having thicknesses of 2× every four cells; and reinforced with primary and secondary zone partitions having thicknesses of 3× every four cells. The isostatic strength of each honeycomb structure was approximated by the inverse of the modeled peak tensile stress intensity factor (normalized) for each honeycomb structure under an applied isostatic pressure of 1 MPa.

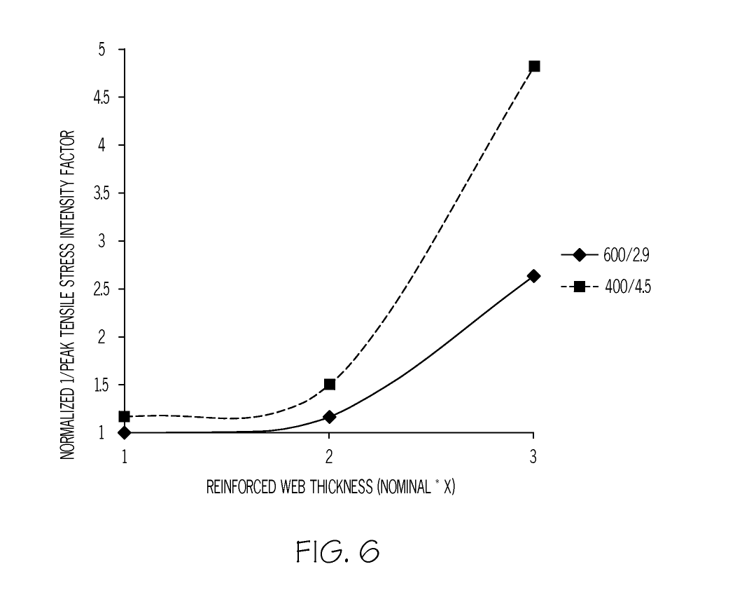

FIG. 6 graphically depicts the calculated isostatic strength of the two honeycomb structures of Example 1 (normalized to the inverse of the peak applied tensile stress intensity factor) as a function of the thickness of the primary zone partitions and the secondary zone partitions. As shown in FIG. 6, adding thickened primary zone partitions and secondary zone partitions to the base structure every four cells significantly increases the effective isostatic strength of each honeycomb, irrespective of the geometry.

### Example 2

Computer simulations of unreinforced honeycomb structures and reinforced honeycomb structures were constructed with varying numbers of defects to assess the isostatic strength of each honeycomb structure as a function of defect density. The unreinforced honeycomb structures had square through channels with a 400/4.5 geometry (400 cells per square inch, wall thickness of 4.5 mils (114.3 microns)). The reinforced honeycomb structures had square through channels with a 400/4.5 geometry (400 cells per square inch, wall thickness of 4.5 mils (114.3 microns)), similar to the first honeycomb structure, but also included primary and secondary zone partitions having a thickness of 3× every four cells. The isostatic strength of the reinforced and unreinforced structures were modeled with web cuts in one, two, and three adjacent channel walls. The isostatic strength of each honeycomb structure was approximated by the inverse of the modeled peak tensile stress intensity factor (normalized) for each honeycomb structure under an applied isostatic pressure of 1 MPa.

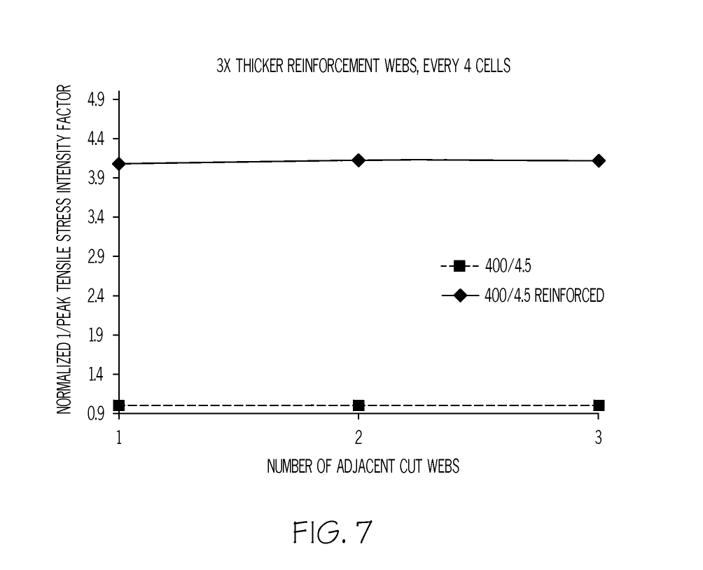

FIG. 7 graphically depicts the calculated isostatic strength of the reinforced honeycomb structures and unreinforced honeycomb structures (normalized to the inverse of the peak applied tensile stress intensity factor) as a function of the number of adjacent channel walls with cut webs in between. As shown in FIG. 7, the reinforced honeycomb structures had significantly higher isostatic strength (greater than 3 times) than the unreinforced honeycomb structures irrespective of the number of defects present in the structure.

### Example 3

Three different honeycomb structures were mathematically modeled. The first honeycomb structure was modeled with square through channels and a 400/4.5 geometry (400 cells per square inch, wall thickness of 4.5 mils (114.3 microns)). The second honeycomb structure was modeled with square through channels and a 400/4.5 geometry (400 cells per square inch, wall thickness of 4.5 mils (114.3 microns)) and included reinforced primary zone partitions and secondary zone partitions every four through channels. The reinforced primary zone partitions and secondary zone partitions were modeled with a thickness three times greater than the channel walls. Accordingly, the first honeycomb structure and the second honeycomb structure had an equivalent underlying structure with the same nominal web thicknesses in the through channels. A third honeycomb structure was modeled with square through channels and a 400/6.85 geometry (400 cells per square inch, wall thickness of 6.85 mils (174 microns)). The second honeycomb structure and the third honeycomb structure had an equivalent bulk density (i.e., the volume of ceramic material was the same in each) and open frontal area.

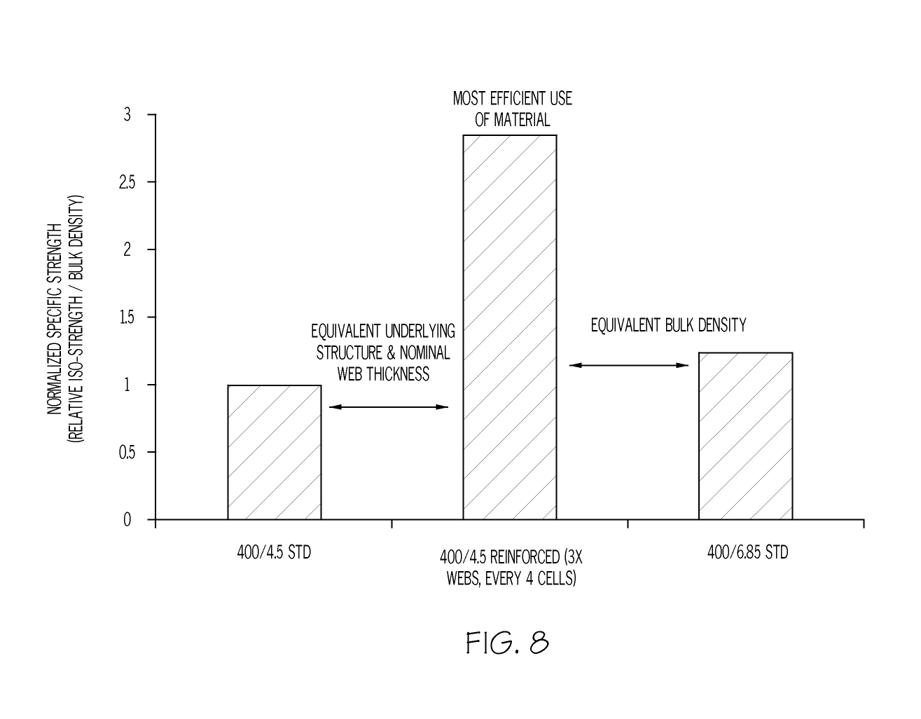

The specific strength for each honeycomb structure (i.e., the isostatic strength) was approximated as the inverse of the peak applied tensile stress intensity factor (normalized) under an applied isostatic pressure of 1 MPa divided by the bulk density of the material. The specific strength for each honeycomb structure is plotted in FIG. 8. As shown in FIG. 8, the specific strength of the second, reinforced honeycomb structure was significantly greater than the first, unreinforced honeycomb structure despite the two honeycomb structures having the equivalent underlying structure and nominal web thicknesses. The second, reinforced honeycomb structure also had a significantly greater specific strength than the third honeycomb structure which had an equivalent bulk density and channel walls which were approximately 1.5 times thicker than the channel walls of the second, reinforced honeycomb structure. This modeled data demonstrates that the second, reinforced structure is significantly advantaged in terms of strength relative to a honeycomb structure with the same underlying structure and relative to a honeycomb structure with the same bulk density but with thicker channel walls.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A ceramic honeycomb structure comprising:
at least one outer wall defining a perimeter of the honeycomb structure;
a plurality of primary zone partitions extending in an axial direction of the honeycomb structure and across a width of the honeycomb structure, wherein the primary zone partitions are substantially parallel with one another and opposite ends of each primary zone partition intersect with the at least one outer wall in the width direction; and
a plurality of secondary zone partitions extending in an axial direction and intersecting with the primary zone partitions, the primary zone partitions and the secondary zone partitions dividing a radial cross section of the honeycomb structure into a plurality of zones, wherein:
the primary zone partitions and the secondary zone partitions have a single-wall thickness with a maximum thickness T_{Zmax};
adjacent zones are separated by a single primary zone partition or a single secondary zone partition;
each zone comprises a plurality of channel walls intersecting to subdivide the zone into a plurality of through channels extending in the axial direction of the honeycomb structure, the plurality of channel walls within each zone having a thickness of at least t_{C}; and
T_{Zmax}>2t_{C}.

2. The honeycomb structure of claim 1, further comprising partial through channels and full through channels, wherein each full through channel of the honeycomb structure is bound by at least one channel wall having thickness t_{C}.

3. The honeycomb structure of claim 1, wherein T_{Zmax}≦10t_{C}.

4. The honeycomb structure of claim 1, wherein a thickness of the plurality of primary zone partitions varies from t_{C} to T_{Zmax}.

5. The honeycomb structure of claim 1, wherein a thickness of the plurality of secondary zone partitions varies from t_{C} to T_{Zmax}.

6. The honeycomb structure of claim 1, wherein adjacent primary zone partitions are separated by at least two through channels.

7. The honeycomb structure of claim 1, wherein the primary zone partitions, the secondary zone partitions, the outerwall, and the plurality of channel walls comprise the same material.

8. The honeycomb structure of claim 1, wherein the primary zone partitions, secondary zone partitions and the channel walls are monolithic.

9. The honeycomb structure of claim 1, wherein the honeycomb structure comprises a cell density greater than or equal to about 100 cpsi and less than or equal to about 900 cpsi.

10. The honeycomb structure of claim 1, wherein t_{C} is greater than or equal to about 25 microns and less than or equal to about 520 microns.

11. The honeycomb structure of claim 1, wherein the through channels are square in cross section.

12. The honeycomb structure of claim 1, wherein the through channels are hexagonal in cross section.

13. The honeycomb structure of claim 1, wherein an isostatic strength of the honeycomb structure is greater than an unreinforced honeycomb structure with a same geometry.

14. The honeycomb structure of claim 1, wherein an isostatic strength of the honeycomb structure is greater than an unreinforced honeycomb structure with a same open frontal area and equivalent bulk density.

15. A ceramic honeycomb structure comprising:
at least one outer wall defining a perimeter of the honeycomb structure;
a plurality of primary zone partitions extending in an axial direction of the honeycomb structure and across a width of the honeycomb structure, wherein the primary zone partitions are substantially parallel with one another, and opposite ends of each primary zone partition intersect with the at least one outer wall in the width direction; and
a plurality of secondary zone partitions extending in an axial direction and intersecting with the primary zone partitions, the primary zone partitions and the secondary zone partitions dividing a radial cross section of the honeycomb structure into a plurality of zones, wherein:
the primary zone partitions and the secondary zone partitions have a single-wall thickness with a maximum thickness T_{Zmax};
adjacent zones are separated by a single primary zone partition or a single secondary zone partition;
each zone comprises a plurality of channel walls intersecting to subdivide the zone into a plurality of through channels extending in the axial direction of the honeycomb structure, the plurality of channel walls within each zone having a thickness less than T_{Zmax} and greater than or equal to t_{C}, wherein the plurality of channel walls within each zone are thicker adjacent to the primary zone partitions and the secondary zone partitions than at a center of each zone; and
T_{Zmax}>2t_{C}.

16. The honeycomb structure of claim 15, wherein the plurality of channel walls within each zone decrease in thickness from a perimeter of each zone to a center of each zone.

17. The honeycomb structure of claim 15, wherein the plurality of channel walls within each zone decreases in thickness from less than about T_{Zmax} to t_{C}.
